(19) United States
(12) Patent Application Publication
(10) Pub. No.: US 2023/0383091 A1
(43) Pub. Date: Nov. 30, 2023

(54) GRAPHENE AS AN ADDITIVE AS A NUCLEATING AGENT

(71) Applicant: Akron Polymer Solutions, Inc., Rancho Santa Margarita, CA (US)

(72) Inventors: Douglas PASCHALL, Rancho Santa Margarita, CA (US); Michael Brendan RODGERS, Leander, TX (US); Adel F. HALASA, Akron, OH (US)

(21) Appl. No.: 18/322,741

(22) Filed: May 24, 2023

Related U.S. Application Data
(60) Provisional application No. 63/365,208, filed on May 24, 2022.

(51) Int. Cl. C08K 3/04; C08L 7/00; C01B 32/194

(52) U.S. Cl. CPC C08K 3/042; C08L 7/00; C01B 32/194; C08L 2205/24; C08K 2201/011; C08K 2201/005; C08K 2201/004; C08K 2201/006; C08K 2201/016; C01B 2204/04; C01B 2204/32; C01B 2204/30; C01B 2204/28

(57) ABSTRACT

A method for improving processing speed, dimensional stability, and physical properties in extruded elastomers is herein disclosed, including the steps of mixing natural rubber with pristine graphene, the pristine graphene acting as a nucleating agent for strain induced crystallization of the natural rubber, and the pristine graphene inducing additional shear during mixing.

The application claims priority to provisional application Ser. No. 63/365,208, filed May 24, 2022, the contents of which are incorporated by reference. Strain crystallization of polymers is well documented and can be of considerable commercial importance. The nucleating process in polymers and specifically elastomers is heterogeneous. It can also be controlled when the nature of the heterogeneities are known. Empirical control can thus be achieved when the nucleating agent is understood. An example is stearic acid which will promote the overall crystallization rate in natural rubber. In polyethylene, particles of silica and aluminum sulphate can similarly function as strain nucleating agents.

### I. BACKGROUND

Graphene is an allotrope of carbon consisting of a single layer of atoms arranged in a two-dimensional honeycomb lattice. The hexagonal lattice structure of isolated, single-layer graphene can be directly seen with transmission electron microscopy (TEM) of sheets of graphene suspended between bars of a metallic grid. Some of these images showed a “rippling” of the flat sheet, with amplitude of about one nanometer. The hexagonal structure is also seen in scanning tunneling microscope (STM) images of graphene supported on silicon dioxide substrates. Ab initio calculations show that a graphene sheet is thermodynamically unstable if its size is less than about 20 nm and becomes the most stable fullerene (as within graphite) only for molecules larger than 24,000 atoms. Each atom in a graphene sheet is connected to its three nearest neighbors by a σ-bond, and contributes one electron to a conduction band that extends over the whole sheet. This is the same type bonding seen in carbon nanotubes and polycyclic aromatic hydrocarbons, and (partially) in fullerenes and glassy carbon. These conduction bands make graphene a semimetal with unusual electronic properties that are best described by theories for massless relativistic particles. Charge carriers in graphene show linear, rather than quadratic, dependence of energy on momentum, and field-effect transistors with graphene can be made that show bipolar conduction. Charge transport is ballistic over long distances; the material exhibits large quantum oscillations and large and nonlinear diamagnetism. Graphene conducts heat and electricity very efficiently along its plane. The material strongly absorbs light of all visible wavelengths, which accounts for the black color of graphite; yet a single graphene sheet is nearly transparent because of its extreme thinness. The material is also about 100 times stronger than would be the strongest steel of the same thickness.

Single layers of carbon atoms are grown epitaxially on top of other materials. This “epitaxial graphene” consists of a single-atom-thick hexagonal lattice of sp 2-bonded carbon atoms, as in free-standing graphene. However, there is significant charge transfer between the two materials, and, in some cases, hybridization between the d-orbitals of the substrate atoms and π orbitals of graphene; which significantly alter the electronic structure compared to that of free-standing graphene.

Three of the four outer-shell electrons of each atom in a graphene sheet occupy three sp² hybrid orbitals—a combination of orbitals s, pₓ and p_{y}—that are shared with the three nearest atoms, forming σ-bonds. The length of these bonds is about 0.142 nanometers. The remaining outer-shell electron occupies a p_{z} orbital that is oriented perpendicularly to the plane. These orbitals hybridize together to form two half-filled bands of free-moving electrons, π and π*, which are responsible for most of graphene's notable electronic properties. Graphene sheets stack to form graphite with an interplanar spacing of 0.335 nm (3.35 Å). Graphene sheets in solid form usually show evidence in diffraction for graphite's layering.

Graphene is a zero-gap semiconductor, because its conduction and valence bands meet at the Dirac points. The Dirac points are six locations in momentum space, on the edge of the Brillouin zone, divided into two non-equivalent sets of three points. The two sets are labeled K and K′. The sets give graphene a valley degeneracy of gv=2. By contrast, for traditional semiconductors the primary point of interest is generally F, where momentum is zero. Four electronic properties separate it from other condensed matter systems. However, if the in-plane direction is no longer infinite, but confined, its electronic structure would change. They are referred to as graphene nanoribbons. If it is “zig-zag,” the bandgap would still be zero. If it is “armchair,” the bandgap would be non-zero. Graphene's hexagonal lattice can be regarded as two interleaving triangular lattices. This perspective was successfully used to calculate the band structure for a single graphite layer using a tight-binding approximation. Electrons propagating through graphene's honeycomb lattice effectively lose their mass, producing quasi-particles that are described by a 2D analogue of the Dirac equation rather than the Schrödinger equation for spin-½ particles.

Graphene displays remarkable electron mobility at room temperature, with reported values in excess of 15000 cm²·V⁻¹·s⁻¹. Hole and electron mobilities are nearly the same. The mobility is independent of temperature between 10 K and 100 K, and shows little change even at room temperature (300 K), which implies that the dominant scattering mechanism is defect scattering. Scattering by graphene's acoustic phonons intrinsically limits room temperature mobility in freestanding graphene to 200000 cm²·V⁻¹·s⁻¹ at a carrier density of 10¹² cm⁻². The corresponding resistivity of graphene sheets would be 10⁻⁶ Ω·cm. This is less than the resistivity of silver, the lowest otherwise known at room temperature. However, on SiO₂ substrates, scattering of electrons by optical phonons of the substrate is a larger effect than scattering by graphene's own phonons. This limits mobility to 40000 cm²·V⁻¹·s⁻¹. Charge transport has major concerns due to adsorption of contaminants such as water and oxygen molecules. This leads to non-repetitive and large hysteresis I-V characteristics. Electrical resistance in 40-nanometer-wide nanoribbons of epitaxial graphene changes in discrete steps. The ribbons' conductance exceeds predictions by a factor of 10. The ribbons can act more like waveguides or quantum dots, allowing electrons to flow smoothly along the ribbon edges. In copper, resistance increases in proportion to length as electrons encounter impurities. Transport is dominated by two modes. One is ballistic and temperature independent, while the other is thermally activated. Ballistic electrons resemble those in cylindrical carbon nanotubes. At room temperature, resistance increases abruptly at a particular length—the ballistic mode at 16 micrometers and the other at 160 nanometers (1% of the former length).

Graphene's permittivity varies with frequency. Over a range from microwave to millimeter wave frequencies it is roughly 3.3. This permittivity, combined with the ability to form both conductors and insulators, means that theoretically, compact capacitors made of graphene could store large amounts of electrical energy. Graphene's unique optical properties produce an unexpectedly high opacity for an atomic monolayer in vacuum, absorbing era 2.3% of light, from visible to infrared. Here, a is the fine-structure constant.

When single-layer graphene is supported on an amorphous material, the thermal conductivity is reduced to about 500-600 W·m⁻¹·K⁻¹ at room temperature as a result of scattering of graphene lattice waves by the substrate, and can be even lower for few layer graphene encased in amorphous oxide. Likewise, polymeric residue can contribute to a similar decrease in the thermal conductivity of suspended graphene to approximately 500 to 600 W·m⁻¹·K⁻¹ for bilayer graphene. It has been suggested that the isotopic composition, the ratio of ¹²C to ¹³C, has a significant impact on the thermal conductivity. For example, isotopically pure ¹²C graphene has higher thermal conductivity than either a 50:50 isotope ratio or the naturally occurring 99:1 ratio. It can be shown by using the Wiedemann-Franz law, that the thermal conduction is phonon-dominated. Potential for this high conductivity can be seen by considering graphite, a 3D version of graphene that has basal plane thermal conductivity of over a 1000 W·m⁻¹K⁻¹ (comparable to diamond). In graphite, the c-axis (out of plane) thermal conductivity is over a factor of ˜100 smaller due to the weak binding forces between basal planes as well as the larger lattice spacing. Despite its 2-D nature, graphene has three acoustic phonon modes. The two in-plane modes (LA, TA) have a linear dispersion relation, whereas the out of plane mode (ZA) has a quadratic dispersion relation. Due to this, the T² dependent thermal conductivity contribution of the linear modes is dominated at low temperatures by the T^{1.5} contribution of the out of plane mode.

The (two-dimensional) density of graphene is 0.763 mg per square meter. Graphene has an intrinsic tensile strength of 130 GPa (19,000,000 psi) (with representative engineering tensile strength ˜50-60 GPa for stretching large-area freestanding graphene) and a Young's modulus (stiffness) close to 1 TPa (150,000,000 psi). The spring constant of suspended graphene sheets has been measured using an atomic force microscope (AFM). Graphene sheets were suspended over SiO₂ cavities where an AFM tip was used to apply a stress to the sheet to test its mechanical properties. Its spring constant was in the range 1-5 N/m and the stiffness was 0.5 TPa, which differs from that of bulk graphite.

Graphene has a theoretical specific surface area (SSA) of 2630 m²/g. This is much larger than for carbon black (typically smaller than 900 m²/g) or for carbon nanotubes (CNTs), from ≈100 to 1000 m²/g and is similar to activated carbon. Graphene is the only form of carbon (or solid material) in which every atom is available for chemical reaction from two sides (due to the 2D structure). Atoms at the edges of a graphene sheet have special chemical reactivity. Graphene has the highest ratio of edge atoms of any allotrope. Defects within a sheet increase its chemical reactivity. The onset temperature of reaction between the basal plane of single-layer graphene and oxygen gas is below 260° C. (530 K). Graphene burns at very low temperature (e.g., 350° C. (620 K)). Examples of types of graphene are monolayer sheets, bilayer graphene, graphene superlattices, graphene nanoribbons, graphene quantum dots, graphene oxide, reduced graphene oxide, pristine graphene, graphene ligand/complex, graphene fiber, 3D graphene, pillared graphene, reinforced graphene, molded graphene, graphene aerogel, graphene nanocoil, and crumpled graphene. The present teaching uses graphene forms which exfoliate into monolayer sheets, as in a polymer nanocomposite, and are of an inert condition, i.e., limited to no chemical functionality such as carboxylic acid, ketone, aldehyde, or hydroxyl groups on the graphene plate surface or plate edges.

### II. SUMMARY

In the present teaching, graphene and specifically inert and partially inert graphene, also referred to as pristine graphene, can be used to improve the mechanical properties of rubber nanocomposites.

Graphene in polymer nanocomposites has been reported to contain many attributes such as antioxidant properties, thermal conductivity, electrical conductivity, and reduction in permeability. Abrasion resistance of rubber nanocomposites is also noted, suggesting better tire wear. In addition, improvement in hysteresis (measured by the loss modulus in shear or in tension (G″ or E″) divided by the storage modulus, either in shear or in tension (G‘ or E’) to calculate the tangent delta) has been noted. In this instance such improvements can facilitate reductions in whole tire rolling resistance, with no loss in traction qualities.

In addition to the thermal properties of graphene, it is reported to show the following properties: electrical conductivity, odorless and no known toxicity, inert, and in polymer composites, demonstrates impermeability. It is therefore desirable to provide graphene as an additive to rubber compounds. Applications where impermeability is desirable are, for example, automotive air conditioning hoses, bladders, rubber sheeting, and the innerliner of a tire. In this specific case, it teaches the reduction of permeability of a tire innerliner beyond that achieved by use of compounded bromobutyl polymers and chlorobutyl polymers, which sometimes is used in automobile air conditioning hose and other comparable applications, such as sheeting.

Still other benefits and advantages of the present subject matter will become apparent to those skilled in the art to which it pertains upon a reading and understanding of the following detailed specification.

### III. BRIEF DESCRIPTION OF THE DRAWINGS

The present teachings are described hereinafter with reference to the accompanying drawings.

FIG. 1 shows the chemical structure of pristine graphene;

FIG. 2 shows the potential states of graphene;

FIG. 3 shows a graph of tear strength;

FIG. 4 shows a graph of abrasion resistance;

FIG. 5 shows the surface topography of truck tire treads; and

FIG. 6 shows a graph of increase in modulus.

### IV. DETAILED DESCRIPTION

### Example 1

Three grades of pristine graphene are described as carriers for both enzymes in bio-systems and as catalysts (Table 1). Though not limited to this, there are three commercial grades of graphene under the commercial name of Prophene*, provided by Akron Polymer Solutions, considered in the present teaching.
Grade PS50 with particle, sheet, or plate sizes of 50 nm to 5 microns;
Grade PS100 with sheet or plate sizes 100 nm to 5 microns and increasing conductivity; and
Grade PS150 with sheet or plate sizes of 150 nm to 10 microns.

Properties in rubber nanocomposites include electrical conductivity, thermal conductivity, improved nanocomposite compound hysteresis, tear strength, abrasion resistance, and reduction in permeability or gas flow.

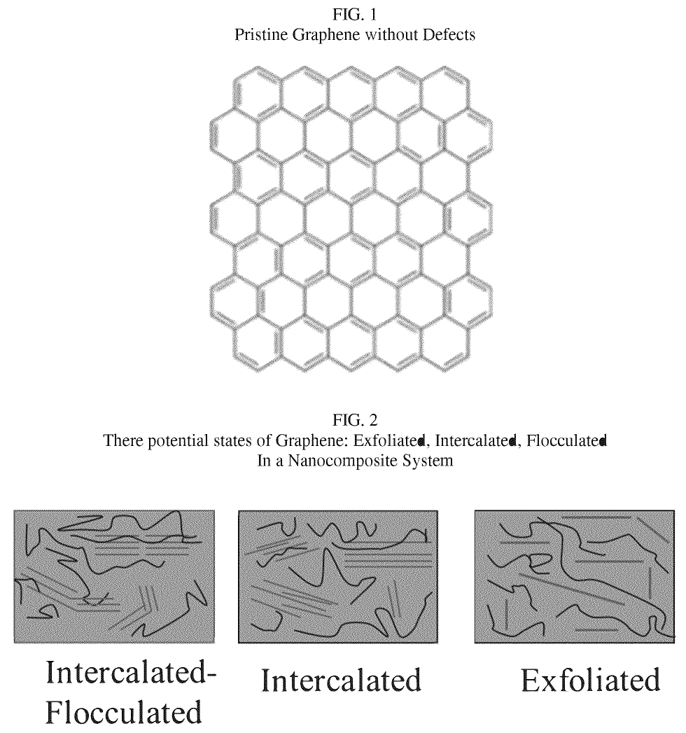

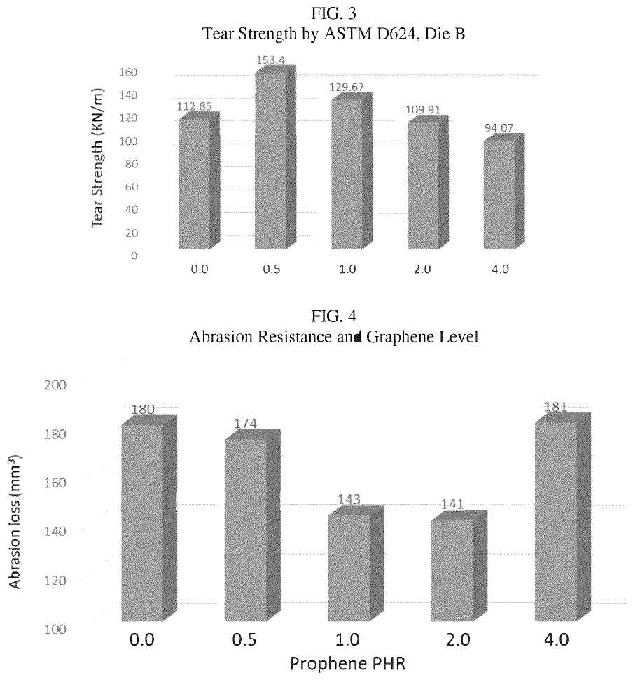

The specific types or grades of graphene described here render their application suitable in bio- and catalysis systems because:
1. No, to very limited, functionality on the graphene plate surface: functionality being presence of reactive groups such as carboxylic acids, aldehyde groups, ketones, quinones, alcohols, and other oxygenated entities, and surface defects such as electronic vacancies in the graphene 6-membered aromatic rings;
2. Potential plate edge minor functionality lending the plates suited to partial immobilization of entities such as catalysts and enzymes (FIG. 1);
3. Very large aspect ratio of graphene, with plates up to ten to fifteen microns; and
4. Ease of exfoliation in many suspension and solution systems.

### Example 2

In rubber nanocomposite systems the graphene plates are believed to be exfoliated, or as a minimum an intercalated state is obtained, i.e., where the graphene is very well dispersed but there are still stacks of pristine graphene plates 2 to 6 layers deep (FIG. 2). The high level of dispersion results in increased shear during composite blending, due to the very large aspect ratio of the graphene plates. The quality, uniformity, and homogeneity of the dispersion is thus improved.

TABLE 1
Properties of Proposed Graphenes for Carriers

| Grade | | PS 50 | PS 100 | PS 150 |
|---|---|---|---|---|
| Form | | Light | Light | Light powder |
| | | powder | powder | |
| Color | | Dark grey/ | Dark grey/ | Dark grey/ |
| | | Black | Black | Black |
| Odor | | None | None | None |
| Resistivity | ohm | <50 | <100 | <150 |
| (Powder) | cm | | | |
| Particle size | nm | 50 nm-5μm | 100 nm-5 μm | 150 nm-10 μm |
| Particle | max | 1.7 nm | 2.5 nm | 2.8 nm |
| thickness | | | | |
| Layer count | < | 10 | <15 | <16 |
| Density | g/cm³ | 2.200 | 2.200 | 2.200 |
| Specific | m²/g | 250.0 | 180.0 | 100.0 |
| surface area | | | | |

The high level of shear thus results in a highly dispersed mixer and high level of mixture homogeneity. This allows for better mechanical properties as observed in rubber nanocomposites.

Such systems also show increased electrical conductivity due to an apparent low percolation point not observed with conventional systems, such as those containing carbon black. Such conductivity might lend itself to uses in built-in antennae for articles such as RFID sensors in tires or other applications.

### Example 3

Graphene was added to the model natural rubber compound illustrated in Table II at levels of 0.5, 1.0, 2.0, 4.0, and 10.0 PHR to give a total of six compounds including the control at -0-PHR. Some observations from the data were as follows:
1. Increase in graphene had no impact on Mooney viscosity (ML1+4), peak Mooney viscosity, or aged Mooney viscosity (7 days at 100° C.). Peak Mooney viscosity has been related to formation of bound rubber which in turn could be due to functional groups on the polymer or filler. The absence of any shifts in viscosity is consistent with the pristine nature of the graphene in this study.
2. There was no shift in vulcanization state of cure, ΔT, maximum torque or MH, or MDR rheometer t90.
3. Vulcanization kinetics determined simply from the cure rate index (equation 1) similarly did not shift.

Cure Rate Index=(t90−t10)/100 (1)

The cure rate index gives a simple means of estimating how a compounding ingredient may influence vulcanization kinetics and, in this instance, no shift was observed. This in turn is consistent with observations of the pristine nature of the graphene samples and no effect of reaction kinetics.

Tensile strength, elongation at break, and 300% modulus were not affected by graphene content. However, tear strength showed a rapid increase at 0.5 PHR and then dropped off as graphene level increased. The result is consistent with the gaussian distribution of tear strength data observed for halobutyl compounds.

TABLE II
Graphene in Truck Tire Compounds

| Compound | Grade | 1 | 2 | 3 | 4 | 5 | 6 |
|---|---|---|---|---|---|---|---|
| Natural Rubber | TSR20 | 100.00 | 100.00 | 100.00 | 100.00 | 100.00 | 100.00 |
| Peptizer (Renecit 11) | | 0.10 | 0.10 | 0.10 | 0.10 | 0.10 | 0.10 |
| Carbon Black | N121 | 50.00 | 50.00 | 50.00 | 50.00 | 50.00 | 50.00 |
| Graphene | | 0.00 | 0.50 | 1.00 | 2.00 | 4.00 | 10.00 |
| Escorez 1102 | | 2.00 | 2.00 | 2.00 | 2.00 | 2.00 | 2.00 |
| TDAE (aromatic oil) | | 3.00 | 3.00 | 3.00 | 3.00 | 3.00 | 3.00 |
| 6PPD | | 2.50 | 2.50 | 2.50 | 2.50 | 2.50 | 2.50 |
| TMQ | | 1.50 | 1.50 | 1.50 | 1.50 | 1.50 | 1.50 |
| Paraffin wax | | 1.00 | 1.00 | 1.00 | 1.00 | 1.00 | 1.00 |
| Microcrystalline wax | | 1.00 | 1.00 | 1.00 | 1.00 | 1.00 | 1.00 |
| Zinc Oxide | | 4.00 | 4.00 | 4.00 | 4.00 | 4.00 | 4.00 |
| Stearic acid | | 2.00 | 2.00 | 2.00 | 2.00 | 2.00 | 2.00 |
| TBBS | | 1.00 | 1.00 | 1.00 | 1.00 | 1.00 | 1.00 |
| Sulfur | | 1.00 | 1.00 | 1.00 | 1.00 | 1.00 | 1.00 |
| PVI | | 0.20 | 0.20 | 0.20 | 0.20 | 0.20 | 0.20 |
| Mooney | ML1 + 4, | | | | | | |
| Viscosity | 100° C. | | | | | | |
| Mooney Peak | | 95.14 | 87.93 | 94.32 | 96.08 | 86.60 | 89.26 |
| ML1 + 4 | | 61.63 | 61.66 | 62.20 | 62.20 | 61.06 | 61.69 |

Aged Mooney Viscosity

| | | | | | | | |
|---|---|---|---|---|---|---|---|
| Mooney Peak | 7 days, 100° C. | 111.60 | 95.40 | 99.90 | 98.80 | 100.40 | 94.80 |
| ML1 + 4 | | 61.70 | 61.50 | 62.00 | 62.10 | 61.30 | 62.00 |

MDR

| | | | | | | | |
|---|---|---|---|---|---|---|---|
| Rheometer | Temperature | 160° C. | 160° C. | 160° C. | 160° C. | 160° C. | 160° C. |
| MH | | 9.67 | 9.56 | 9.89 | 9.77 | 9.67 | 10.05 |
| ML | | 1.85 | 1.75 | 1.9 | 1.81 | 1.78 | 1.86 |
| Delta Torque | | 7.82 | 7.81 | 7.99 | 7.96 | 7.89 | 8.19 |
| Torque at t10 | | 2.63 | 2.53 | 2.70 | 2.61 | 2.57 | 2.68 |
| Torque at t50 | | 5.76 | 5.66 | 5.90 | 5.79 | 5.73 | 5.96 |
| Torque at t90 | | 8.89 | 8.78 | 9.09 | 8.97 | 8.88 | 9.23 |
| t10 | | 2.55 | 2.45 | 2.65 | 2.52 | 2.45 | 2.66 |
| t50 | | 4.47 | 4.53 | 4.51 | 4.50 | 4.48 | 4.51 |
| t90 | | 6.73 | 6.76 | 6.81 | 6.67 | 6.88 | 6.91 |
| CRI | | 23.92 | 23.20 | 24.04 | 24.10 | 22.57 | 23.53 |

TABLE V
(Continued)
Graphene in Truck Tire Compounds

| | | | | | | | |
|---|---|---|---|---|---|---|---|
| Compound | Grade | 1 | 2 | 3 | 4 | 5 | 6 |

| | | | | | | |
|---|---|---|---|---|---|---|
| Natural Rubber | 100.00 | 100.00 | 100.00 | 100.00 | 100.00 | 100.00 |
| Peptizer (Renecit 11) | 0.10 | 0.10 | 0.10 | 0.10 | 0.10 | 0.10 |
| Carbon Black | 50.00 | 50.00 | 50.00 | 50.00 | 50.00 | 50.00 |
| Graphene | 0.00 | 0.50 | 1.00 | 2.00 | 4.00 | 10.00 |

Tensile Strength: ASTM D412 Die C

| | | | | | | | |
|---|---|---|---|---|---|---|---|
| Tensile | MPa | 26.00 | 27.00 | 26.00 | 26.60 | 26.70 | 25.00 |
| Strength | | | | | | | |
| Elongation | % | 568 | 565 | 577 | 593 | 583 | 519 |
| 50% modulus | MPa | 1.18 | 1.15 | 1.20 | 1.23 | 1.35 | 1.60 |
| 100% modulus | MPa | 2.10 | 2.00 | 2.10 | 2.20 | 2.50 | 3.10 |
| 200% modulus | MPa | 5.90 | 5.90 | 5.90 | 5.80 | 6.50 | 7.40 |
| 300% modulus | MPa | 11.30 | 11.40 | 11.50 | 11.00 | 11.90 | 13.00 |

Tensile Strength: ASTM D412 Die C AGED 7 days 100 C.

| | | | | | | | |
|---|---|---|---|---|---|---|---|
| Tensile | MPa | 26.04 | 23.93 | — | 24.81 | — | 23.53 |
| Strength | | | | | | | |
| Elongation | % | 494 | 478 | — | 486 | — | 453 |
| 100% modulus | MPa | 3.25 | 2.89 | — | 3.21 | — | 4.43 |
| 200% modulus | MPa | 8.73 | 7.53 | — | 8.13 | — | 9.43 |
| 300% modulus | MPa | 15.08 | 13.58 | — | 14.43 | — | 15.54 |
| Energy at | J/m3 | 59.92 | 50.99 | — | 55.63 | — | 52.05 |
| Break | | | | | | | |
| Tensile | | 100 | 89 | — | 93 | — | 94 |
| Strength | | | | | | | |
| Elongation | | 87 | 85 | — | 82 | — | 87 |
| 300% Modulus | | 133 | 119 | — | 131 | — | 120 |

1″ strip Tensile Strength

| | | | | | | | |
|---|---|---|---|---|---|---|---|
| Tensile | MPa | 10.94 | 12.44 | 11.35 | 12.29 | 13.59 | 15.40 |
| Strength | | | | | | | |
| Elongation | % | 296 | 329 | 312 | 322 | 346 | 343 |
| 50% modulus | MPa | 1.09 | 1.12 | 1.15 | 1.19 | 1.23 | 1.60 |
| 100% modulus | MPa | 1.92 | 2.01 | 2.02 | 2.18 | 2.25 | 3.20 |

### Example 4

Potential Mechanisms for Graphene Functionality in Natural Rubber Compounds

Five compounds were selected with graphene increasing from 0.0 PHR to 4.00 PHR and Din abrasion measured (FIG. 4). Volume loss measured after the test showed a significant reduction (improvement) beginning at 0.5 PHR through to 2.0 PHR, after which there was an inflection upwards in volume losses. Low levels of graphene can thus have a significant impact on performance.

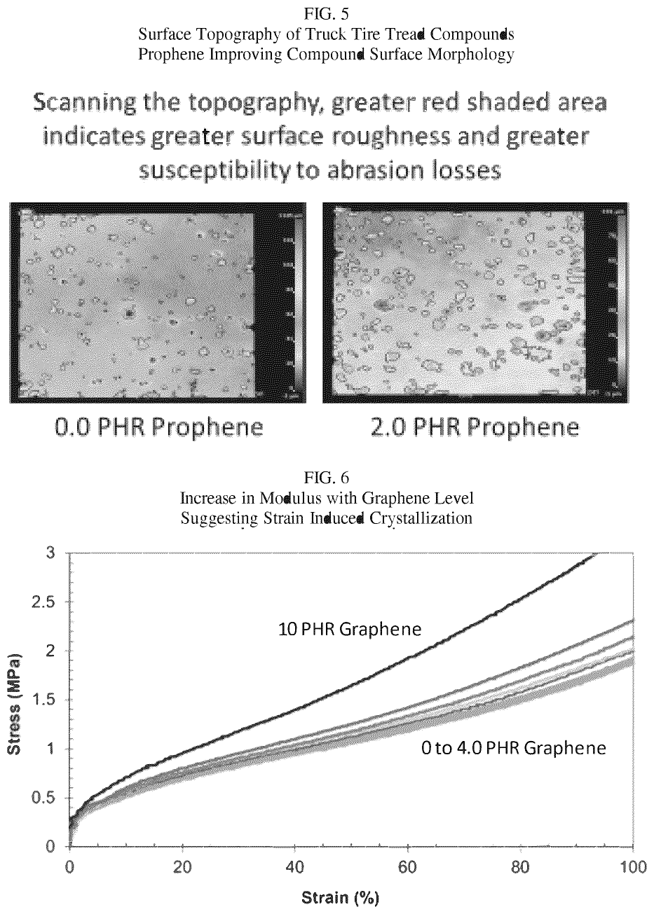

A potential explanation could be compound homogeneity, with the graphene plates inducing additional shear during compound mixing, achieving better dispersion, and in turn improved abrasion resistance. Scanning the topography of test specimens, the greater red shaded area indicates greater surface roughness and greater susceptibility to abrasion losses (FIG. 5).

In order to further elucidate a possible mechanism for this phenomenon, tensile strength properties were further studied. Tensile strength measured using 2.5 cm wide strips of compound had been reported as a simple means of identifying if a compounding additive served as nucleating agent for strain induced crystallization in natural rubber. This has been observed here. As graphene level increased and as strains exceeded 50%, modulus increased.

Thus, graphene will improve the properties of a natural rubber compound via four mechanisms:
1. As a nucleating agent for strain induced crystallization of natural rubber chains;
2. Improvement of tear strength both via rubber strain crystallization and deflection of tear propagation;
3. Antioxidant properties; and
4. Improved compound homogeneity and component dispersion.

Though all four mechanisms would participate, improvement due to strain crystallization would dominate.

Non-limiting aspects have been described, hereinabove. It will be apparent to those skilled in the art that the above methods and apparatuses may incorporate changes and modifications without departing from the general scope of the present subject matter. It is intended to include all such modifications and alterations in so far as they come within the scope of the appended claims or the equivalents thereof.

Having thus described the present teachings, it is now claimed:

We claim:

1. A method for improving processing speed, dimensional stability, and physical properties in extruded elastomers, the method comprising the steps of:
mixing natural rubber with pristine graphene;
the pristine graphene acting as a nucleating agent for strain induced crystallization of the natural rubber; and
the pristine graphene inducing additional shear during mixing.

2. The method of claim 1 further comprising the steps of:
exfoliating the pristine graphene; and,
dispersing the pristine graphene in the natural rubber.

3. The method of claim 1, wherein Mooney viscosity, tensile strength, elongation at break, and 300% modulus of the mixture of natural rubber and pristine graphene is substantially the same as that of natural rubber alone.

4. The method of claim 1, wherein the pristine graphene has a thickness of less than about 3.2 nm, a particle size of between about 50 nm and about 10 μm, and contains greater than about 95% carbon.

5. The method of claim 1, wherein the pristine graphene is present in an amount of between about 0.1 PHR and about 50.0 PHR.

6. The method of claim 5, wherein the pristine graphene has a surface area from about 100 m²/gram to about 250 m²/gram.

7. The method of claim 6, wherein the pristine graphene has an oxygen content of less than about 1%.

8. The method of claim 7, wherein the thickness of the pristine graphene is less than about 1 nm and the aspect ratio of the pristine graphene is about 1000.

9. The method of claim 5, wherein the pristine graphene is present in an amount of between about 0.5 PHR and about 8.0 PHR.

10. The method of claim 9, wherein the pristine graphene is present in an amount of between about 1.0 PHR and about 2.0 PHR, wherein the mixture of natural rubber and pristine graphene has no clay fillers.

11. The method of claim 1, wherein the pristine graphene has substantially no carboxylic acids, alcohols, ketones, aldehydes, or other oxygenated or nitrogen functional groups.

12. A composition made according to claim 1.

13. The composition of claim 12, wherein the pristine graphene has a thickness of less than about 3.2 nm, a particle size of between about 50 nm and about 10 μm, and contains greater than about 95% carbon.

14. The composition of claim 12, wherein the pristine graphene is present in an amount of between about 0.1 PHR and about 50.0 PHR.

15. The composition of claim 14, wherein the pristine graphene has a surface area from about 100 m²/gram to about 250 m²/gram.

16. The composition of claim 15, wherein the pristine graphene has an oxygen content of less than about 1%.

17. The composition of claim 16, wherein the thickness of the pristine graphene is less than about 1 nm and the aspect ratio of the pristine graphene is about 1000.

18. The composition of claim 14, wherein the pristine graphene is present in an amount of between about 0.5 PHR and about 8.0 PHR.

19. The composition of claim 18, wherein the pristine graphene is present in an amount of between about 1.0 PHR and about 2.0 PHR, wherein the mixture of natural rubber and pristine graphene has no clay fillers.

20. The composition of claim 12, wherein the pristine graphene has substantially no carboxylic acids, alcohols, ketones, aldehydes, or other oxygenated or nitrogen functional groups.
